(19) United States
(12) Patent Application Publication
(10) Pub. No.: US 2014/0361892 A1
(43) Pub. Date: Dec. 11, 2014

(54) Locking GPS Device for Locating Children

(71) Applicant: Malcolm Larry Borlenghi, Westfield, NJ (US)

(72) Inventor: Malcolm Larry Borlenghi, Westfield, NJ (US)

(21) Appl. No.: 14/456,469

(22) Filed: Aug. 11, 2014

Related U.S. Application Data
(63) Continuation-in-part of application No. 13/694,211, filed on Nov. 7, 2012.

(51) Int. Cl. G08B 21/02

(52) U.S. Cl. CPC G08B 21/0269
USPC 340/539.13

(57) ABSTRACT

A GPS-based child-locator device can be securely locked to a child's wrist or ankle so as to be removable only by using one or more custom mechanical keys and/or resettable software keys/codes. This prevents the child-locator device from being disabled by being removed from the child during an abduction. The GPS locator comprises a housing unit, a connecting band, by which the housing unit is attachable to a child, and a locking mechanism, by which the connecting band is lockably attachable to the housing unit. The GPS locator also utilizes a novel antenna design to achieve a very compact profile for the housing which contains the device's electrical components.

### REFERENCE TO RELATED APPLICATION

This application is a Continuation-in-Part of application Ser. No. 13/694,211, which was filed on Nov. 7, 2012, and the disclosure of which is incorporated herein by reference.

### FIELD OF INVENTION

The present invention relates to the general field of GPS devices and more particularly to GPS devices for locating children.

### BACKGROUND OF THE INVENTION

The prior art in this field discloses several GPS-based locator devices, which are wearable by a child and/or concealable on his/her person. These devices generally comprise a GPS receiver and a transmitter component, such as a wireless telephone. Examples of such devices are described in the U.S. patent application publications of Wong (2004/0198382 A1) and Levanen (2009/0042534 A1), the disclosures of which are incorporated herein by reference.

A major disadvantage of the prior art GPS child-locator devices is that they can be readily defeated by removing the device from the child's person. Since the availability of such GPS locators has been widely publicized, a kidnapper or sexual predator is likely to search a child after an abduction for such a device and remove it, thereby rendering its tracking function inoperative.

Another critical problem of the prior art GPS child-locator designs is the need to accommodate wireless telephonic transmission/reception components within a housing that is compact enough to be worn on or attached to the child's body without obstructing his/her movements.

The present invention addresses the deficiencies in the prior art GPS-based child-locator devices by providing a device which can be securely locked to a child's wrist or ankle so as to be removable only by using one or more custom mechanical keys and/or resettable software keys/codes. The present invention also utilizes a novel antenna design to achieve a very compact profile for the housing which contains the device's electrical components.

### SUMMARY OF THE INVENTION

The locking GPS-based locator device, wearable by a child, comprises a housing unit, a connecting band, by which the housing unit is attachable to the child, and a locking mechanism, by which the connecting band is lockably attachable to the housing unit. The housing unit has a proximal side and a distal side and defines a housing interior space, which contains a GPS module, a cellular module, one or more high band antennas in electrical communication with the cellular module and the GPS module, a processing circuit, and a power source. The connecting band has a distal end, which is fixedly attached to the distal side of the housing unit, and a proximal end, which is lockably attachable through the locking mechanism to the proximal side of the housing unit. The connecting band also contains one or more low-band antennas, which communicate electrically with the cellular module in the housing unit.

The GPS module, upon activation, is configured to receive satellite GPS location data for a current location of the locator device and to transmit the GPS location data to the processing circuit, which converts the GPS location date to one or more outgoing locator message signals, in text or audible format, that are sent by the cellular module through one of the high-band or low-band antennas to one or more designated contacts. The GPS module is activated in a response mode, through the processing circuit, by the cellular module in response to a location request, in text or audible format, received through one of the high-band or low-band antennas. The GPS is also activated in a periodic mode by the processing circuit at designated intervals.

In order to operate effectively on a wireless telephonic network, the cellular module of the locator device must be capable of transmitting and receiving at both a high-frequency and a low-frequency band. The two predominant bands used in U.S. wireless networks are the 850 MHz low-band, which transmits at 824-849 MHz and receives at 869-894 MHz, and the 1900 MHz high-band, which transmits at 1850-1910 MHz and receives at 1930-1990 MHz. More generally, low-band antennas operate in the range of 700-1000 MHz, while high-band antennas operate in the range of 1700-2200 MHz.

Since the optimal size of an antenna increases in relation to the wavelength of the signals it transmits/receives, an effective low-band antennas must be substantially larger than its high-band counterpart. Consequently, the footprint required for an effective low-band antenna would demand a housing unit too large to be comfortably worn by a child on the wrist or ankle For that reason, the design of the present invention locates the low-band antenna(s) in the connecting band, rather than in the housing unit.

In order to enable the low-band antennas to be located in the connecting band, the processing circuit includes a diplex filter, in electrical communication with the cellular module, which separates the outgoing locator message signals into high-pass frequencies and low-pass frequencies, with the high-pass frequencies going to the high-band antenna(s) in the housing unit, and the low-pass frequencies going to the low-band antenna(s) in the connecting band, as shown in FIG. 21.

While the locking mechanism can be a mechanical one, a conventional keyed tumbler lock will not fit within the constrained housing interior space. The locking mechanism can comprise a custom mechanical locking system, in which an array of locking springs on the proximal side of the housing unit conjugately engage a cooperating array of band apertures in the proximal end of the connecting band, as shown in FIG. 22. A flat key with a horizontal array of projections of different lengths, corresponding to positions of the locking springs, when inserted, without turning, into a key opening between the locking springs and the band apertures, lifts the locking springs, thereby releasing the proximal end of the connecting band from the proximal side of the housing unit.

Alternately, or in conjunction with the custom mechanical locking system, the locking mechanism can comprise an electromagnetic locking mechanism, having a de-energized locked configuration, in which a spring-loaded plunger pin extending through the proximal side of the housing unit conjugately engages a cooperating band aperture in the proximal end of the connecting band, as shown in FIG. 23B. In the energized unlocked configuration of the electromagnetic locking mechanism, the electromagnet generates on a magnetic field which draws the plunger pin away from the band aperture so that it disengages, thereby releasing the proximal end of the connecting band from the proximal side of the housing unit, as shown in FIG. 23A.

For maximum tamper-proof security, the housing unit is preferably made of a high-strength thermoplastic, such as polycarbonate. The connecting band can consist of a high-strength thermoplastic polymer reinforced with a titanium alloy. Both the housing unit and the connecting band are water proof and fire resistant.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a perspective view of the invention with a chain type band.

FIG. 2 is a perspective view of the invention with a flat band.

FIG. 3 is an exploded view of the bottom side of the locking mechanism of the flat band invention.

FIG. 4 is an exploded view of the top side of the locking mechanism of the flat band invention.

FIG. 5 is a side view of the flat band invention.

FIG. 6 is a top view of the flat band invention.

FIG. 7 is a bottom view of the flat band invention.

FIG. 8 is a perspective view of the front of the flat band invention.

FIG. 9 is a perspective view of the back of the flat band invention.

FIG. 10 is a side cross-section view of the invention of FIG. 6, along the line 11-11.

FIG. 11 is a top cross-section view of the invention of FIG. 5, along the line 10-10.

FIG. 12 is an exploded view of the bottom side of the locking mechanism of the chain type band invention.

FIG. 13 is an exploded view of the top side of the locking mechanism of the chain type band invention.

FIG. 14 is a side view of the chain type band invention.

FIG. 15 is a top view of the chain type band invention.

FIG. 16 is a bottom view of the chain type band invention.

FIG. 17 is a perspective view of the front of the chain type band invention.

FIG. 18 is a perspective view of the back of the chain type band invention.

FIG. 19 is a side cross-section view of invention of FIG. 15, along the line 19-19.

FIG. 20 is a top cross-section view of the invention of FIG. 14, along the line 18-18.

FIG. 21 is a schematic diagram of the high-band and low-band antennas configuration of the present invention.

FIG. 22 is a side cross-section view of the custom mechanical locking mechanism of the present invention.

FIG. 23A is a perspective interior view of the electromagnetic locking mechanism of the present invention in the energized, unlocked configuration.

FIG. 23B is a side cross-section view of the electromagnetic locking mechanism of the present invention in the de-energized, locked configuration.

### DETAILED DESCRIPTION OF THE PREFERRED EMBODIMENT

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

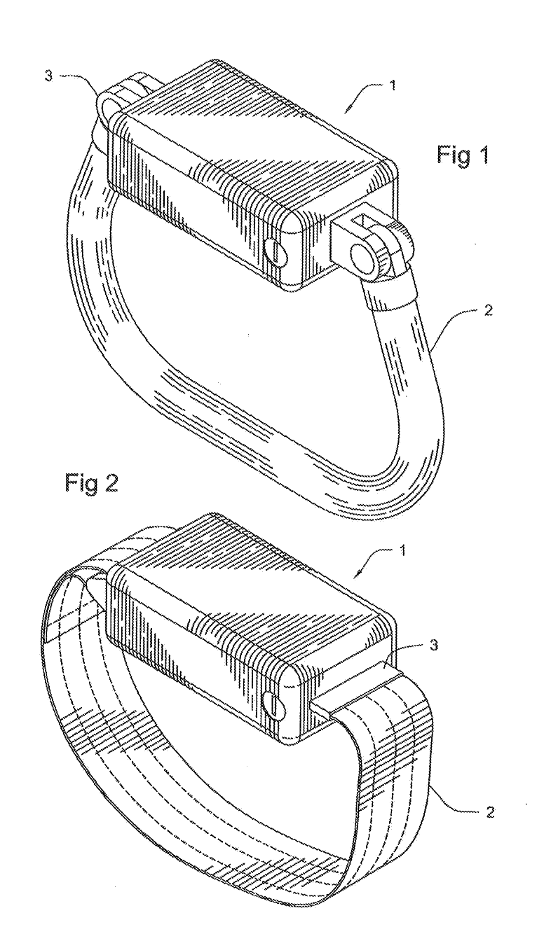

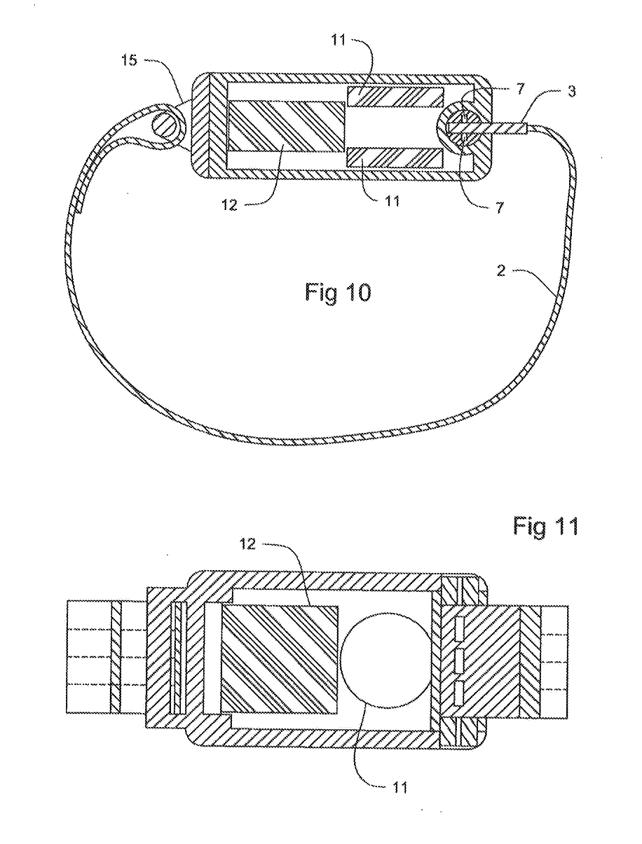

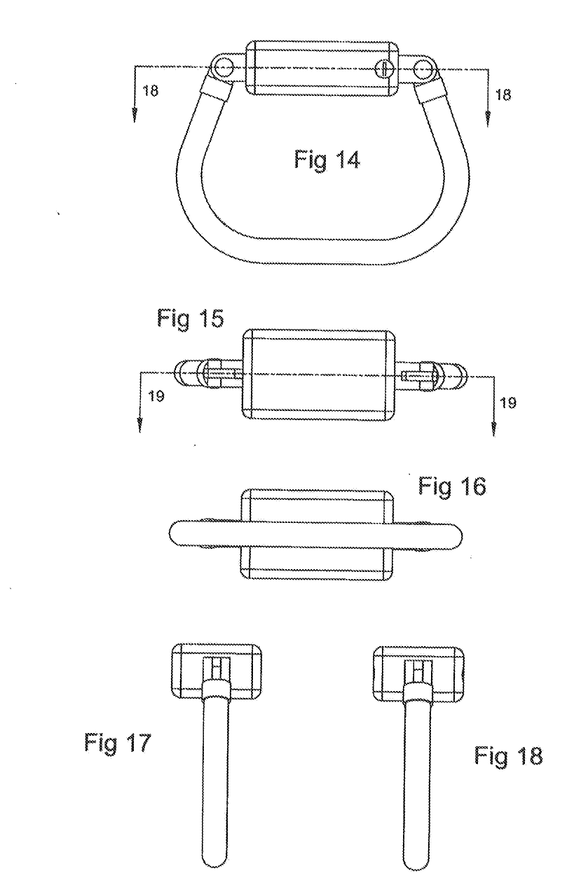

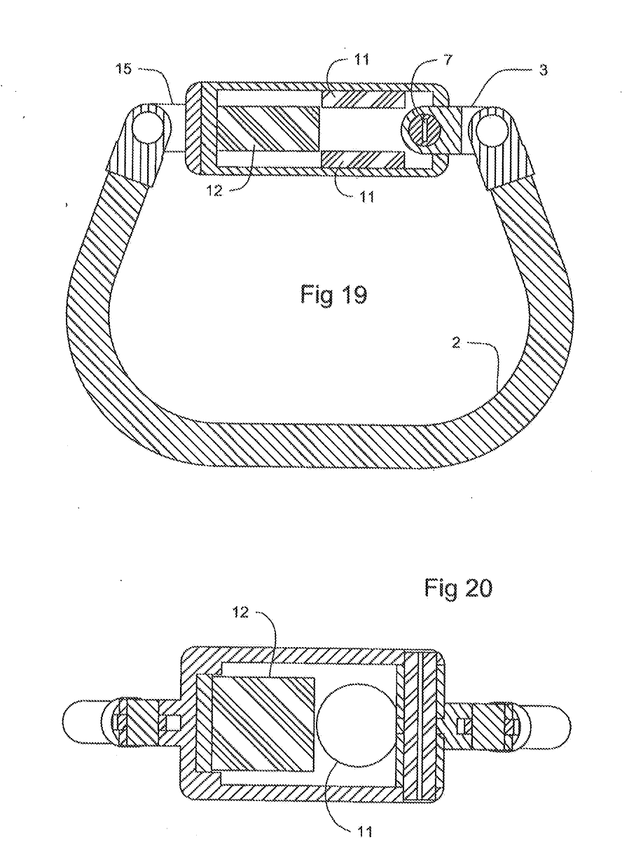

An apparatus for housing a GPS device for locating children according to the present invention will now be described in detail with reference to FIGS. 1 through 24 of the accompanying drawings. More particularly, an apparatus housing a GPS device for locating children FIG. 1 according to the present invention includes a housing unit 1 and a flat band 2 (FIG. 2) or chain band 2 (FIG. 1).

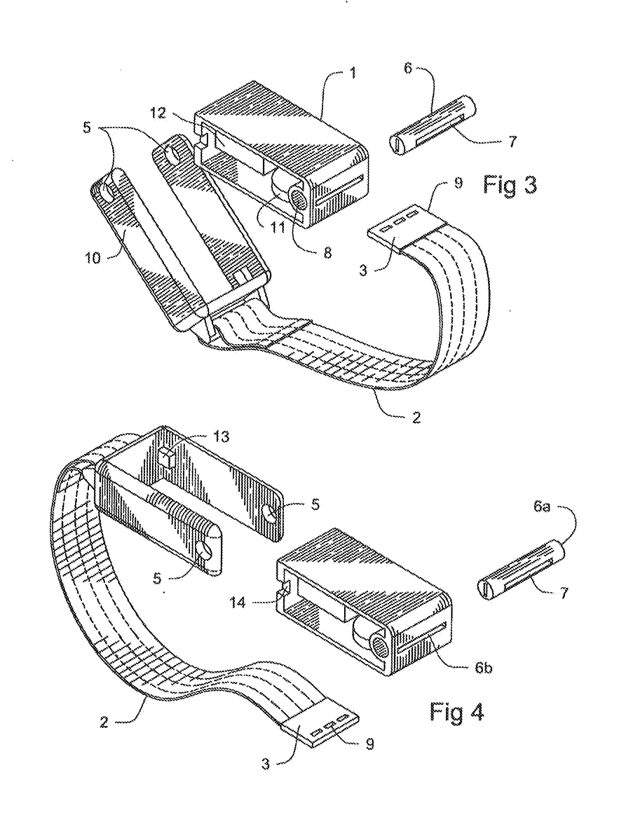

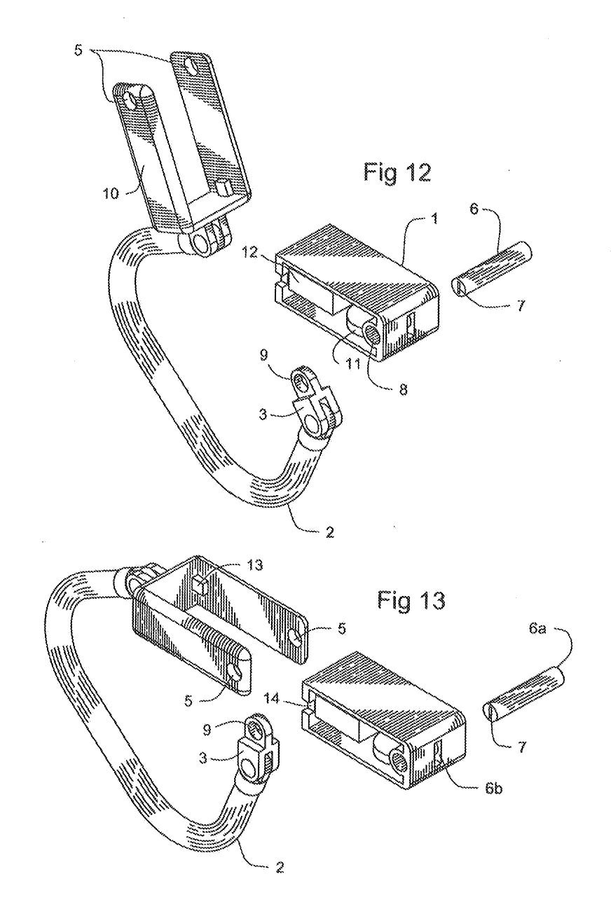

The housing unit 1 (shown in FIGS. 3 and 4 for the flat band, and FIGS. 12 and 13 for the chain band) houses a small “thermoplastic” internal water and fire proof container 12, which holds the GPS module. The housing unit 1 also contains a storage unit 11 for two lithium batteries to power the GPS module.

The housing unit 1 (shown in FIGS. 3 and 4 for the flat band, and FIGS. 12 and 13 for the chain band) contains a locking mechanism 6a and 6b that can only be opened with a special designed key. The locking mechanism is comprised of the male portion of the locking mechanism 6a and the female portion 6b. The male portion of the locking mechanism 6a is a cylinder shaped pin that contains a key insert 4 and an opening containing three teeth 7 that latch on to the male insert 3 and its grooves 9. The male portion of the locking mechanism 6a slides and attaches itself through the female portion of the locking mechanism 6b, through the locking pin cavity 8 and cylinder pin apertures 5 contained in 10.

The band portion of the invention 2 (shown in FIGS. 3 and 4 for the flat band, and FIGS. 12 and 13 for the chain band) is comprised of a swivel hinge 10 containing two cylinder pin sized holes 5. The band portion 2 also contains a male connector 3 with three grooves 9 that insert into the locking mechanism 6a and 6b.

The swivel hinge 10 contains studs 13 which slide into the housing unit 1 through grooves 14 and is locked into place by the locking mechanism 6a and 6b after the male connector 3 slides through the female portion of the locking mechanism 6b and locks into place by the lock teeth 7 going through the locking grooves 9.

Both locking mechanisms create a safe and stable environment for the child and parent as the band and housing cannot be cut, or destroyed by fire, or water. This keeps the GPS device active and functioning which allows the parent to locate the missing child.

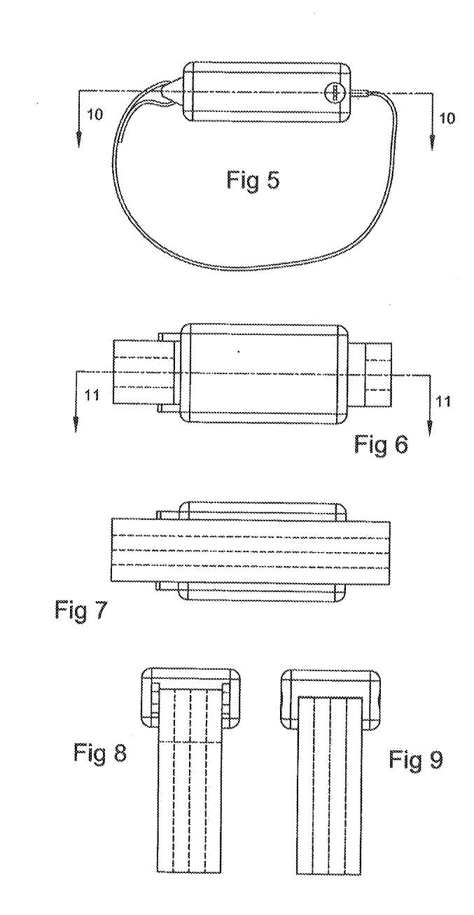

FIGS. 5, 14 and 15 identify the size of the housing. FIGS. 7 and 8 identify the flat band 2 and FIGS. 16, 17 and 18 identify the chain band 2.

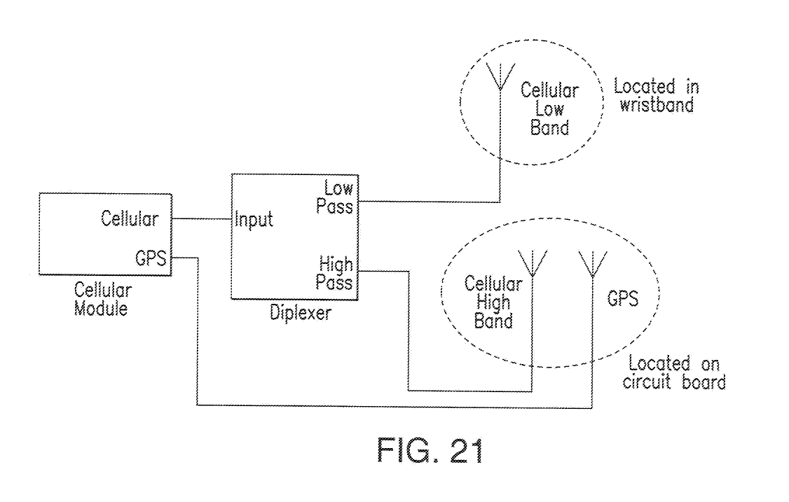

FIG. 21 schematically depicts the high-band and low-band antenna configurations of the present invention, as described hereinabove.

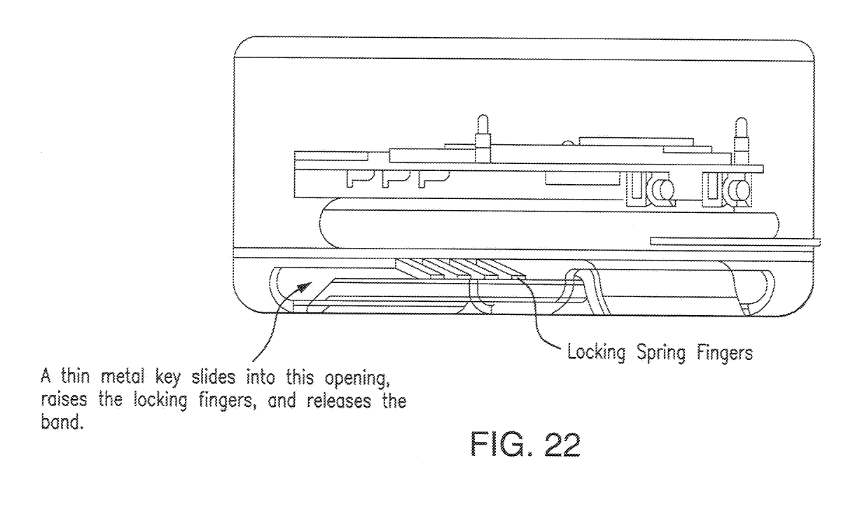

FIG. 22 depicts the custom mechanical locking mechanism of the present invention, as described hereinabove.

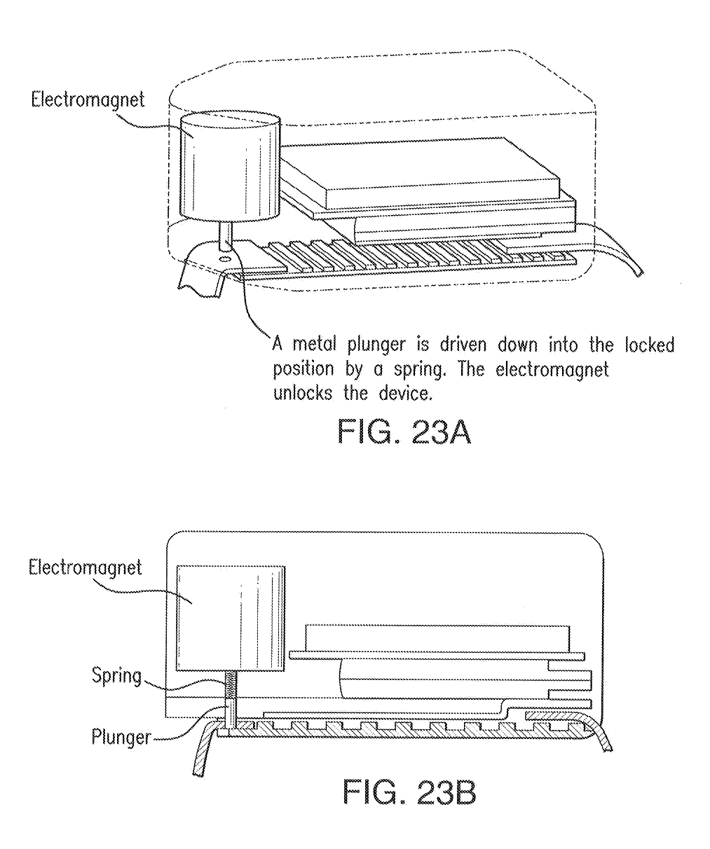

FIG. 23B depicts the electromagnetic locking mechanism of the present invention, as described hereinabove, in the de-energized, locked configuration.

FIG. 23A depicts the electromagnetic locking mechanism of the present invention, as described hereinabove, in the energized, unlocked configuration.

What is claimed is:

1. A locking GPS-based locator device, wearable by a child, comprising:
a housing unit, a connecting band, by which the housing unit is attachable to the child, and a locking mechanism, by which the connecting band is lockably attachable to the housing unit;
wherein the housing unit, having a proximal side and a distal side, defines a housing interior space, which contains a GPS module, a cellular module, one or more high-band antennas in electrical communication with the cellular module and the GPS module, a processing circuit, and a power source;
wherein the connecting band has a distal end, which is fixedly connected to the distal side of the housing unit, and a proximal end, which is lockably attachable to the proximal side of the housing unit;
wherein the connecting band contains one or more low-band antennas, which communicate electrically with the cellular module in the housing unit; and
wherein the GPS module, upon activation, is configured to receive satellite GPS location data and to transmit the GPS location data to the processing circuit, which converts the GPS location data to one or more outgoing locator message signals, in text or audible format, which signals are sent by the cellular module, through one or more of the high-band or the low-band antennas, to one or more designated contacts.

2. The locator device of claim 1, wherein the GPS module is activated in a response mode, through the processing circuit, by the cellular module responding to a location request, in text or audible format, received through one or more of the high-band or the low-band antennas.

3. The locator device of claim 2, wherein the GPS module is activated in a periodic mode by the processing circuit at designated intervals.

4. The locator device of claim 3, wherein the processing circuit includes a diplex filter in electrical communication with the cellular module, and wherein the diplex filter separates the outgoing locator message signals into high-pass frequencies and low-pass frequencies, and wherein the diplex filter directs the high-pass frequencies to one or more of the high-band antennas in the housing unit, and wherein the diplex filter directs the low-pass frequencies to one or more of the low-band antennas in the connecting band.

5. The locator device of claim 4, wherein the locking mechanism comprises a mechanical locking mechanism, and wherein the mechanical locking mechanism comprises an array of locking springs in the proximal side of the housing unit, which locking springs conjugately engage a cooperating array of band apertures in the proximal end of the connecting band, thereby locking the proximal end of the connecting band to the proximal side of the housing unit, and wherein the locking mechanism further comprises a flat key having a horizontal pattern of key projections corresponding to positions of the locking springs, which key projections are configured so that the key projections, upon the key being inserted, without turning, into a key opening between the locking springs and the band apertures, lift the locking springs and cause the locking springs to disengage from the cooperating band apertures, thereby releasing the proximal end of the connecting band from the proximal side of the housing unit.

6. The locator device of claim 4, wherein the locking mechanism comprises an electromagnetic locking mechanism, comprising an electromagnet in electrical communication with the power source and a spring compressively connected to a ferromagnetic plunger pin, and wherein, when the electromagnet is electrically de-energized, the spring forces the plunger pin to extend through a pin opening in the proximal side of the housing unit and to engage conjugately a cooperating band opening in the proximal end of the connecting band, thereby locking the proximal end of the connecting band to the proximal side of the housing unit, and wherein, when the electromagnet is electrically energized, the electromagnet attracts the plunger pin so as to draw the plunger pin away from the band opening and to cause the plunger pin to disengage from the band opening, thereby releasing the proximal end of the connecting band from the proximal side of the housing unit.

7. The locator device of claim 6, wherein the processing circuit contains a Near Field Communication (NFC) component, and wherein the electromagnet is electrically energized in response to an NFC-transmitted unlocking code.
